(19) United States
(12) Patent Application Publication
(10) Pub. No.: US 2004/0234753 A1
(43) Pub. Date: Nov. 25, 2004

(54) Flame-retardant pressure-sensitive adhesive, processes for preparing it, and its use for producing a pressure-sensitive adhesive tape

(75) Inventors: Marc Husemann, Hamburg (DE); Stephan Zollner, Hamburg (DE)

Correspondence Address: NORRIS, MCLAUGHLIN & MARCUS, P.A., 875 THIRD AVE, 18TH FLOOR, NEW YORK, NY, 10022, US

(73) Assignee: tesa Aktiengesellschaft, Hamburg (DE)

(21) Appl. No.: 10/796,231

(22) Filed: Mar. 9, 2004

(30) Foreign Application Priority Data
Mar. 18, 2003 (DE) 103 12 031.9

(51) Int. Cl. B32B 7/12; C08L 33/04

(52) U.S. Cl. 428/343; 428/523; 525/55

(57) ABSTRACT

The invention relates to a flame-retardant and substantially solvent-free pressure-sensitive adhesive, to a process for preparing it and to its use for pressure-sensitive adhesive tapes.

The pressure-sensitive adhesive of the invention comprises

(a) at least one acrylate adhesive component,

(b) at least one ammonium polyphosphate component and

(c) at least one resin component.

Coating one or both sides of a flame-retardant-impregnated carrier tape with a pressure-sensitive adhesive produces a flame-retardant pressure-sensitive adhesive tape.

The invention relates to a flame-retardant, substantially solvent-free pressure-sensitive adhesive, to processes for preparing it and to its use for producing a pressure-sensitive adhesive tape.

### BACKGROUND OF THE INVENTION

A host of applications exist for which pressure-sensitive adhesive tapes are required to be flame retardant. For many offices or public buildings, for example, the legislator prescribes stringent requirements in relation to the flame retardancy of the construction materials used. Since in some cases these materials must also be bonded, the same requirements are imposed on the pressure-sensitive adhesive tapes used. Another sector is that of transport. On aircraft or onboard ships a host of construction materials are likewise required to be flame retardant or completely non-flammable. Here again, bonding is carried out with flame-retardant pressure-sensitive adhesive tapes in a host of applications.

In computer technology, too, increasing numbers of electronic components are being bonded to one another. Miniaturization as well is imposing ever more exacting requirements on the pressure-sensitive adhesive tapes. For instance, very high temperatures may arise in some instances in the electronic circuits, or the pressure-sensitive adhesive tapes are required to be resistant to wave soldering. The wave soldering bath is used, for example, to produce soldered connections on circuits. The temperatures which occur here exceed 280° C., with a consequent risk that the pressure-sensitive adhesive tapes will ignite at these temperatures.

Alongside the abovementioned requirements for flame retardancy there naturally exists a host of secondary applications: in the computer industry, for example, low solvent outgassing, long-term stability even under UV light, and a wide service temperature range. These secondary requirements can be met very effectively by double-sided pressure-sensitive adhesive tapes featuring acrylate pressure-sensitive adhesives. Polyacrylates, though, have the disadvantage of high flammability and so do not meet the requirements for flame retardancy.

As a result, flame retardants are added to these pressure-sensitive adhesives. This technique is already well established. For example, phosphate, bromine or chlorine compounds, aluminum compounds or sulphur compounds can be used. Use of the halogen-containing additives in particular is nowadays only very limited, on environmental grounds, since any possible recycling operation may involve release of dioxins and other ecotoxins. The other additives have disadvantages too, since they impair the adhesive properties, in particular lowering the bond strength, and must be added in high proportions.

It is an object of the present invention, therefore, to provide a flame-retardant and very largely solvent-free pressure-sensitive adhesive which meets the requirements set out above. The pressure-sensitive adhesive ought to be suitable in particular for producing flame-retardant pressure-sensitive adhesive tapes which meet the most exacting safety requirements.

### SUMMARY OF THE INVENTION

This object is achieved by means of a flame-retardant pressure-sensitive adhesive comprising

(a) at least one acrylate adhesive component,

(b) at least one ammonium polyphosphate component and

(c) at least one resin component.

Surprisingly and unforeseeably for the person skilled in the art a pressure-sensitive adhesive formulated as above has very little, if any, tendency towards inflammation and has a very low solvent content. At the same time the bond strength of the pressure-sensitive adhesive of the invention is improved over that of conventional pressure-sensitive adhesives.

### DETAILED DESCRIPTION

The pressure-sensitive adhesive can be used with particular advantage for producing flame-retardant pressure-sensitive adhesive tapes, which preferably comprise a carrier tape impregnated with a flame retardant and coated on one or both sides with the pressure-sensitive adhesive of the invention. Details relating to the production of the pressure-sensitive adhesive tapes are given below.

Pressure-sensitive Adhesive

The pressure-sensitive adhesive (PSA) of the invention is preferably composed of at least 35% by weight of the at least one acrylate adhesive component, at least 25% by weight of ammonium polyphosphate, in particular from 30 to 40% by weight, and at least 25% by weight of the at least one resin component. The at least one acrylate adhesive component has an average molecular mass M_{w} of not more than 600 000 g/mol.

As the major component of the PSA it is preferred to use acrylate and/or methacrylate PSAs, i.e. PSAs based essentially on at least one (meth)acrylate monomer, possibly in the form of a copolymer with one or more comonomers. In the finished product the monomer/comonomer mixture may already be fully polymerized or only partly polymerized.

The monomers/comonomers used for preparing these compositions are selected such that the resultant polymers can be used as PSAs at room temperature, in particular such that the resultant polymers possess pressure-sensitive adhesion properties, in accordance for example with the Handbook of Pressure Sensitive Adhesive Technology by Donatas Satas (van Nostrand, N.Y. 1989).

In order to obtain a preferred glass transition temperature T_{g} of the polymers, of ≦25° C. for PSAs which are employed preferentially at room temperature, in accordance with the above remarks the monomers are very preferably selected, and the quantitative composition of the monomer mixture advantageously likewise selected, in such a way that the desired T_{g} of the polymer is obtained from the Fox equation (G1) (cf. T. G. Fox, Bull. Am. Phys. Soc. 1 (1956) 123):

$$\frac{1}{{T}_{g}} = {\sum }_{n} \frac{{w}_{n}}{{T}_{g , n}} \qquad ( G1 )$$

In this formula, n represents the serial number of the monomers used, wₙ the mass fraction of the respective monomer n (% by weight), and T_{g,n} the respective glass transition temperature of the homopolymer of the respective monomer n, in kelvins.

In one advantageous embodiment of the invention the at least one acrylate adhesive component, having a mass fraction of preferably at least 35% in the PSA, is based on at least one acrylate monomer of the general formula (1)

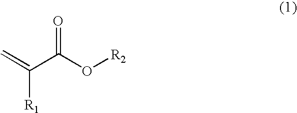

in which R₁ is H or a CH₃ radical and R₂ is H or is selected from the group consisting of saturated, branched and unbranched, substituted and unsubstituted C₁ to C₃₀ alkyl radicals.

The R₂ radical of these acrylate monomers may also be substituted by functional groups, selected in particular from carboxyl, sulphonic acid, hydroxyl, lactam, lactone, N-substituted amide, N-substituted amine, carbamate, epoxy, thiol, alkoxy, cyano, halide and ether radicals.

In one very preferred mode the acrylate or methacrylate monomers used comprise acrylic or methacrylic esters having alkyl groups of 4 to 14 carbon atoms, preferably of 4 to 9 carbon atoms. Specific examples, without wishing to be restricted by this enumeration, include methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and their branched isomers, such as isobutyl acrylate, 2-ethylhexyl acrylate, 2-ethylhexyl methacrylate, isooctyl acrylate and isooctyl methacrylate, for example.

Further classes of compound which can be used include (meth)acrylates having bridged cycloalkyl radicals of at least 6 carbon atoms. The cycloalkyl alcohols can also be substituted, by C₁ to C₆ alkyl groups, halide groups or cyano groups or the like, for example. Specific examples include cyclohexyl methacrylates, isobornyl acrylate, isobornyl methacrylates and 3,5-dimethyladamantyl acrylate.

In one preferred procedure use is made as comonomers of compounds which carry at least one substituent, especially polar groups such as carboxyl, sulphonic acid, hydroxyl, lactam, lactone, N-substituted amide, N-substituted amine, carbamate, epoxy, thiol, alkoxy, cyanide, halide or ether groups or the like.

Moderately basic comonomers which are likewise suitable include singly or doubly N-alkyl-substituted amides, especially acrylamides, for example N,N-dimethylacrylamide, N,N-dimethylmethacrylamide, N-tert-butylacrylamide, N-vinylpyrrolidone, N-vinyllactam, N-methylolacrylamide, N-methylolmethacrylamide, N-(butoxymethyl)methacrylamide, N-(ethoxymethyl)acrylamide and N-isopropylacrylamide, this enumeration not being exhaustive.

Further preferred examples of comonomers are hydroxyethyl acrylate, hydroxyethyl methacrylate, hydroxypropyl acrylate, hydroxypropyl methacrylate, allyl alcohol, maleic anhydride, itaconic anhydride, itaconic acid, glyceridyl methacrylate, phenoxyethyl acrylate, phenoxyethyl methacrylate, 2-butoxyethyl acrylate, 2-butoxyethyl methacrylate, cyanoethyl acrylate, cyanoethyl methacrylate, glyceryl methacrylate, 6-hydroxyhexyl methacrylate, vinylacetic acid, tetrahydrofuryl acrylate, β-acryloyloxypropionic acid, trichloroacrylic acid, fumaric acid, crotonic acid, aconitic acid and dimethylacrylic acid, this enumeration not being exhaustive.

In one further very preferred procedure the comonomers used include vinyl compounds, especially vinyl esters, vinyl ethers, vinyl halides, vinylidene halides, and vinyl compounds having aromatic rings and heterocycles in α position. Here again mention may be made non-exclusively of some examples, such as vinyl acetate, vinylformamide, vinylpyridine, ethyl vinyl ether, vinyl chloride, vinylidene chloride and acrylonitrile.

In a further procedure, optionally, photoinitiators having a copolymerizable double bond are also used as a comonomer. Suitable photoinitiators include Norrish-I and II photoinitiators. Examples include benzoin acrylate and an acrylated benzophenone from UCB (Ebecryl P 36®). In principle it is possible to copolymerize any photoinitiators known to the person skilled in the art which are able to crosslink the polymer by a free-radical mechanism under UV irradiation. An overview of possible photoinitiators that can be used, and which can be functionalized with a double bond, is given in Fouassier: “Photoinitiation, Photopolymerization and Photocuring: Fundamentals and Applications”, Hanser-Verlag, Munich, 1995. For further details use is made of Carroy et al. in “Chemistry and Technology of UV and EB Formulation for Coatings, Inks and Paints”, Oldring (ed.), 1994, SITA, London.

In a further preferred procedure monomers having a high static glass transition temperature are added to the comonomers described. Aromatic vinyl compounds are suitable components, an example being styrene, in which case the aromatic nuclei are preferably composed of C₄ to C₁₈ units and may also contain heteroatoms. Particularly preferred examples are 4-vinylpyridine, N-vinylphthalimide, methylstyrene, 3,4-dimethoxystyrene, 4-vinylbenzoic acid, benzyl acrylate, benzyl methacrylate, phenyl acrylate, phenyl methacrylate, t-butylphenyl acrylate, t-butylphenyl methacrylate, 4-biphenylyl acrylate, 4-biphenylyl methacrylate, 2-naphthyl acrylate, 2-naphthyl methacrylate, and mixtures of these monomers, this enumeration not being exhaustive.

A further constituent of the PSA is an ammonium polyphosphate of at least 25% by weight. The upper limit is dependent on the monomer/comonomer composition of the polyacrylate and also on the preferred tack of the system. At ammonium polyphosphate mass fractions of greater than 60% by weight the PSA is no longer flammable, but only has a low tack. One very preferred version of the invention uses between 30% and 40% by weight of the ammonium polyphosphate. Ammonium polyphosphates are available commercially, under the trade name Exolit® 422, for instance.

A further constituent of the PSAs are resins. As tackifying resins to be added it is possible without exception to use all known tackifier resins and those described in the literature. As representatives mention may be made of pinene resins, indene resins and rosins, their disproportionated, hydrogenated, polymerized, esterified derivatives and salts, the aliphatic and aromatic hydrocarbon resins, terpene resins and terpene-phenolic resins, C₅ to C₉ hydrocarbon resins, and other hydrocarbon resins. Any desired combinations of these and further resins can be used in order to adjust the properties of the resultant adhesive in accordance with what is desired. Generally speaking it is possible to use all resins which are compatible with (soluble in) the corresponding poly(meth)acrylate; particular reference may be made to all aliphatic, aromatic and alkylaromatic hydrocarbon resins, hydrocarbon resins based on single monomers, hydrogenated hydrocarbon resins, functional hydrocarbon resins and natural resins. Express reference may be made to the depiction of the state of the art in the Handbook of Pressure Sensitive Adhesive Technology by Donatas Satas (van Nostrand, 1989). In one very preferred version terpene-phenolic resins and C₅-C₉ hydrocarbon resins are admixed.

A further, optional possibility is to add phosphate plasticizers, incombustible fillers, microbeads of other materials, silica, silicates, nucleators, expandants, compounding agents and/or ageing inhibitors, the latter in the form, for example, of primary and secondary antioxidants or of light stabilizers. In one preferred version oligophosphate plasticizers are added.

It is additionally possible to mix in crosslinkers and crosslinking promoters. Suitable crosslinkers for electron beam crosslinking and UV crosslinking are, for example, difunctional or polyfunctional acrylates, difunctional or polyfunctional isocyanates (including those in blocked form) or difunctional or polyfunctional epoxides.

For optional crosslinking with UV light it is possible to add UV-absorbing photoinitiators to the PSA. Useful photoinitiators whose use is very effective include benzoin ethers, such as benzoin methyl ether and benzoin isopropyl ether, substituted acetophenones, such as 2,2-diethoxyacetophenone (e.g. Irgacure 651® from Ciba Geigy®), 2,2-dimethoxy-2-phenyl-1-phenylethanone, dimethoxyhydroxyacetophenone, substituted α-ketols, such as 2-methoxy-2-hydroxypropiophenone, aromatic sulphonyl chlorides, such as 2-naphthylsulphonyl chloride, and photoactive oximes, such as 1-phenyl-1,2-propanedione 2-(O-ethoxycarbonyl) oxime, for example.

The abovementioned photoinitiators and others which can be used, and further initiators of the Norrish I or Norrish II type, may contain the following radicals: benzophenone, acetophenone, benzil, benzoin, hydroxyalkylphenone, phenyl cyclohexyl ketone, anthraquinone, trimethylbenzoylphosphine oxide, methylthiophenyl morpholinyl ketone, amino ketone, azobenzoin, thioxanthone, hexaarylbisimidazole, triazine or fluorenone radicals, each of these radicals being unsubstituted or additionally substituted by one or more halogen atoms and/or one or more alkyloxy groups and/or one or more amino groups or hydroxyl groups. A representative overview is given by Fouassier (“Photoinitiation, Photopolymerization and Photocuring: Fundamentals and Applications”, Hanser-Verlag, Munich, 1995). For further details it is possible to consult Carroy et al. (in “Chemistry and Technology of UV and EB Formulation for Coatings, Inks and Paints”, Oldring (ed.), 1994, SITA, London).

Preparation Processes for the Pressure-sensitive Adhesive

The invention further provides a process for preparing the flame-retardant pressure-sensitive adhesive, wherein

(a) at least one acrylate adhesive component is prepared by at least partly polymerizing at least one acrylate monomer, in the presence if desired of at least one comonomer,

(b) successively or simultaneously at least one ammonium polyphosphate component and at least one resin component are combined with the at least one acrylate adhesive component.

To prepare the poly(meth)acrylate component it is advantageous to conduct conventional radical polymerizations with the monomers, in the presence if desired of the comonomers. For the free-radical polymerizations, with preferably thermal initiation, it is preferred to use initiator systems which further include other radical polymerization initiators, especially thermally decomposing, radical-forming azo or peroxo initiators. In principle, however, all customary initiators familiar to the person skilled in the art for acrylates are suitable. The production of C-centered radicals is described in Houben Weyl (Methoden der Organischen Chemie, Vol. E 19a, pp. 60-147). These methods are preferentially employed analogously.

Examples of suitable radical sources are peroxides, hydroperoxides and azo compounds. A number of non-exclusive examples of typical radical initiators that may be mentioned here include potassium peroxodisulphate, dibenzoyl peroxide, cumene hydroperoxide, cyclohexanone peroxide, di-t-butyl peroxide, azodiisobutyronitrile, cyclohexanesulphonyl acetyl peroxide, diisopropyl percarbonate, t-butyl peroctoate and benzpinacol. In one very preferred version the radical initiator used is 1,1′-azobis(cyclohexanecarbonitrile) (Vazo 88™ from DuPont) or azodiisobutyronitrile (AIBN).

The maximum molecular weights M_{w} of the acrylate adhesive component of 600 000 g/mol are determined by size exclusion chromatography (GPC) or matrix-assisted laser desorption/ionization coupled with mass spectrometry (MALDI-MS).

The polymerization can be conducted in bulk, in the presence of one or more organic solvents, in the presence of water or in mixtures of organic solvents and water. The aim is to minimize the amount of solvent used. Suitable organic solvents are simple alkanes (e.g. hexane, heptane, octane, isooctane), aromatic hydrocarbons (e.g. benzene, toluene, xylene), esters (e.g. ethyl, propyl, butyl or hexyl acetate), halogenated hydrocarbons (e.g. chlorobenzene), alkanols (e.g. methanol, ethanol, ethylene glycol, ethylene glycol monomethyl ether) and ethers (e.g. diethyl ether, dibutyl ether) or mixtures thereof. A water-miscible or hydrophilic cosolvent can be added to the aqueous polymerization reactions in order to ensure that the reaction mixture is in the form of a homogeneous phase during monomer conversion. Cosolvents which can be used with advantage for the present invention are selected from the group consisting of aliphatic alcohols, glycols, ethers, glycol ethers, pyrrolidines, N-alkylpyrrolidinones, N-alkylpyrrolidones, polyethylene glycols, polypropylene glycols, amides, carboxylic acids and their salts, esters, organic sulphides, sulphoxides, sulphones, alcohol derivatives, hydroxy ether derivatives, amino alcohols, ketones and the like, and also derivatives and mixtures thereof.

The polymerization time varies in accordance with conversion and temperature and is between 2 and 72 hours. The higher the reaction temperature that can be chosen, in other words the higher the thermal stability of the reaction mixture, the lower the possible reaction time.

For the thermally decomposing initiators, the introduction of heat is essential to initiate the polymerization. In this case the polymerization can be initiated by heating at from 50 to 160° C., depending on initiator type.

For the preparation it may also be of advantage to polymerize the acrylate adhesive component in bulk. In this case the prepolymerization technique is especially suitable. The polymerization is initiated with UV light but taken only to a low conversion of about 10 to 30%. This polymer syrup can then be welded into films, for example (in the simplest case, as ice cubes) and then polymerized onto a high conversion in water. The resultant pellets can then be employed as an acrylate hotmelt adhesive, the film materials used for the melting operation being preferably materials compatible with the polyacrylate. For this preparation method as well the thermally conductive materials can be added before or after the polymerization.

In further versions of the invention the inventive PSAs are prepared using controlled radical or living polymerization processes.

Another advantageous preparation process for the poly(meth)acrylate PSAs is that of anionic polymerization. In this case the reaction medium used preferably comprises inert solvents, such as aliphatic and cycloaliphatic hydrocarbons, for example, or else aromatic hydrocarbons.

Production of the flame-retardant PSA tapes takes place advantageously by coating from hotmelt systems, in other words from the melt (see below). For the production process it may therefore be necessary to remove the solvent from the PSA prior to coating. In principle any of the techniques known to the person skilled in the art can be used here. One very preferred technique is that of concentrating using a single-screw or twin-screw extruder. The twin-screw extruder can be operated with corotating or counterrotating screws. The solvent or water is preferably distilled off over two or more vacuum stages. There is also external heating in accordance with the distillation temperature of the solvent. The residual solvent contents amount in particular to less than 1%, preferably less than 0.5% and more preferably less than 0.2%. The hotmelt is processed further from the melt.

In one very preferred process the resins and/or the ammonium polyphosphate are compounded in the melt. Compounding to the melt takes place preferably in a twin-screw extruder or planetary roll extruder. Shear energy brings about homogeneous distribution of the resins and of the ammonium polyphosphate.

Coating, Carrier, Crosslinkinq

For coating in the hotmelt it is possible to employ a variety of coating methods. In one embodiment the inventive PSAs are coated by way of a roller coating process. Different roller coating processes are described in the Handbook of Pressure Sensitive Adhesive Technology by Donatas Satas (van Nostrand, N.Y. 1989). In another embodiment the PSAs are coated by way of a melt die. A distinction can be made here between the contact process and the contactless process. In a further process, the inventive PSA is applied by extrusion coating. Extrusion coating is performed preferably using an extrusion die. The extrusion dies used may originate advantageously from one of the following categories: T-die, fishtail die and coathanger die. The individual types differ in the design of their flow channel.

For the inventive PSA tapes the PSAs are coated onto the nonwoven, PET web, woven fabric or woven/nonwoven composite. This can be done directly or in a transfer process. For coating in a transfer process the PSA film is first deposited on an in-process liner or a siliconized or fluorinated release paper and then laminated to the carrier.

In order to achieve a high level of flame retardancy the carrier of the flame-retardant PSA tape is impregnated with a flame retardant. A particularly effective flame retardant for this purpose is Flovan® from Pfersee.

An option after the carrier tape has been coated with the PSA is UV crosslinking. This is done by irradiation using short-wave ultraviolet radiation in a wavelength range from 200 to 400 nm, depending on the UV photoinitiator used, making use in particular of high-pressure or mediumpressure mercury lamps with an output of from 80 to 240 W/cm. The intensity of irradiation is adapted to the particular quantum yield of the UV photoinitiator and to the degree of crosslinking that is to be set.

Furthermore, in one preferred process, the inventive PSA can be crosslinked using electron beams. Typical of the irradiation apparatus that can be employed are linear cathode systems, scanner systems or segmented cathode systems, when the apparatus in question comprises electron bean accelerators. A detailed description of the state of the art and of the most important process parameters is given in Skelhorne (Electron Beam Processing, in Chemistry and Technology of UV and EB Formulation for Coatings, Inks and Paints, Vol. 1, 1991, SITA, London). Typical acceleration voltages are in the range between 50 and 500 kV, preferably between 80 and 300 kV. The doses employed range between 5 to 150 kGy, in particular between 20 and 100 kGy.

Both crosslinking methods can also be used in combination with one another, or other methods which allow high energy irradiation can be used.

Further advantageous embodiments of the invention are provided in the remaining dependent claims.

Working Examples

The invention is described below by means of experiments, without any intention that the choice of samples investigated should unnecessarily restrict the invention.

The following test methods were employed:

Gel Permeation Chromoatography GPC (Test A)

The average molecular weight M_{w} and the polydispersity PD were determined by gel permeation chromatography. The mobile phase used was THF containing 0.1% by volume trifluoroacetic acid. Measurement was made at 25° C. The precolumn used was PSS-SDV, 5μ, 10³ Å, ID 8.0 mm×50 mm. Separation was carried out using the columns PSS-SDV, 5μ, 10³ and 10⁵ and 10⁶ Å each with ID 8.0 mm×300 mm. The sample concentration was 4 g/l, the flow rate 1.0 ml per minute. Measurement was made against PMMA standards.

Flame Retardancy (Test B)

Investigation of flame retardancy can be carried out in accordance with UL-94 VTM-0, ISO 9772, ISO 9773 and IEC 60707. For the purposes of this invention, the inventive PSAs were tested in accordance with DIN 40633, and in that system Z 3=combustible, Z 2=self-extinguishing and Z 1=incombustible.

180° Bond Strength (Test C)

A strip 20 mm wide of a PSA coated onto polyester was applied to steel plates. Longitudinal or transverse specimens were bonded to the steel plate, depending on direction and orientation. The PSA strip was pressed onto the substrate twice, using a 2 kg weight. The adhesive tape was then immediately peeled from the substrate at an angle of 180° and at 30 mm/min. The steel plates were washed twice with acetone and once with isopropanol. The results are reported in N/cm and are averaged from three measurements. All measurements were carried out at room temperature under standardized climate conditions.

Residual Solvent (Test D)

The residual solvent fractions were determined gravimetrically. 2 g of the acrylate hotmelt PSA were placed in a metal can, which was stored open in a drying cabinet at 120° C. The weight was then measured again. The difference between the original weight of the PSA and the final measured weight is expressed in percentage terms as the residual solvent loss.

Preparation of the Samples

### REFERENCE EXAMPLE 1

A 2 L glass reactor conventional for radical polymerizations was charged with 8 g of acrylic acid, 392 g of 2-ethylhexyl acrylate and 300 g of acetone/isopropanol (90:10). After nitrogen gas had been passed through the reactor for 45 minutes with stirring the reactor was heated to 58° C. and 0.2 g of 2,2-azobis(2-methylbutyronitrile) (Vazo67®, DuPont) was added. Thereafter the external heating bath was heated to 75° C. and the reaction was carried out constantly at this external temperature. After a reaction time of 1 h a further 0.2 g Vazo 67 was added. After 3 h and 6 h dilution was carried out with 150 g of an acetone/isopropanol mixture (90/10) each time. To reduce the residual initiators two portions of 0.4 g of di(4-tert-butylcyclohexyl) peroxydicarbonate (Perkadox 16®, Akzo Nobel) were added, once after 8 h and then after 10 h. The reaction was terminated after a reaction time of 22 h and the product was cooled to room temperature.

Determination of the molecular weight by test A gave an M_{w} of 470 000 g/mol with a polydispersity M_{w}/Mₙ of 4.3.

The adhesive was then freed from the solvent with heating and under reduced pressure, and was coated as a hotmelt through a die onto a siliconized release paper (from Laufenberg) (application taking place at a rate of 50 g/m²). This system was then laminated onto both sides of a 50 μm thick nonwoven impregnated with flame retardant Flovan (Pfersee). The PSAs were crosslinked with 60 kGy and 200 kV EB.

The PSA tape thus produced was tested by methods B, C and D.

### REFERENCE EXAMPLE 2

Reference Example 1 was repeated. Prior to hotmelt coating, the polymer was blended in an extruder with 30% by weight of magnesium hydroxide/aluminum hydroxide (Martinal OL-104S).

### REFERENCE EXAMPLE 3

Reference Example 1 was repeated. Prior to hotmelt coating, the polymer was blended in an extruder with 45% by weight of magnesium hydroxide/aluminum hydroxide (Martinal OL-104S).

### REFERENCE EXAMPLE 4

Reference Example 1 was repeated. Prior to hotmelt coating, the polymer was blended in an extruder with 15% by weight of microencapsulated red phosphorus (Safest S3).

### REFERENCE EXAMPLE 5

Reference Example 1 was repeated. Prior to hotmelt coating, the polymer was blended in an extruder with 60% by weight of oligophosphate (Reofos 65™ from Great Lake Chemicals).

### REFERENCE EXAMPLE 6

Reference Example 1 was repeated. Prior to hotmelt coating, the polymer was blended in an extruder with 20% by weight of ammonium polyphosphate (Pyrovatex).

### EXAMPLE 1

An acrylate adhesive component was prepared in analogy to Reference Example 1. Prior to hotmelt coating, the polymer was blended in an extruder with 30% by weight of ammonium polyphosphate (Exolit 422) and 30% by weight of terpene-phenolic resin (Dertophene DT 110).

### EXAMPLE 2

An acrylate adhesive component was prepared in analogy to Reference Example 1. Prior to hotmelt coating, the polymer was blended in an extruder with 30% by weight of ammonium polyphosphate (Exolit 422) and 30% by weight of C₅-C₉ resin (TK 90, VFT Rüttgers).

### EXAMPLE 3

An acrylate adhesive component was prepared in analogy to Reference Example 1. Prior to hotmelt coating, the polymer was blended in an extruder with 30% by weight of ammonium polyphosphate (Exolit 422), 30% by weight of C₅-C₉ resin (TK 90, VFT Rüttgers) and 5% by weight of oligophosphate (Reofos 65, Great Lake Chemicals).

Results

In a first step the flame retardancy of the pressure-sensitive adhesives from all the examples was measured. Categorization was in accordance with DIN 40633, as Z=1 (incombustible), Z=2 (self-extinguishing) and Z=3 (combustible). The results are summarized in Table 1.

TABLE 1
Flame retardancy according to test B.

| Example | Flame retardancy (test B) |
|---|---|
| Reference Example 1 | Z = 3 |
| Reference Example 2 | Z = 3 |
| Reference Example 3 | Z = 2 |
| Reference Example 4 | Z = 2 |
| Reference Example 5 | Z = 3 |
| Reference Example 6 | Z = 2 |
| Example 1 | Z = 1 |
| Example 2 | Z = 1 |
| Example 3 | Z = 1 |

Table 1 reveals that only the PSAs of the inventive Examples 1 to 3 attained the highest rating of Z=1 and so these PSAs are absolutely incombustible. The PSAs of the invention are therefore superior even to those reference adhesives lacking only the resin component in relation to the composition described here.

For further characterization of the inventive PSAs a measurement was made of the bond strength on steel of the PSA tapes produced using them, in accordance with test C. The values found are summarized in Table 2.

TABLE 2
Bond strength on steel according to test C.

| | Bond strength on steel (test C) |
|---|---|
| Example | in [N/cm] |
| Reference Example 1 | 5.2 |
| Reference Example 2 | 1.4 |
| Reference Example 3 | 1.0 |
| Reference Example 4 | 4.1 |
| Reference Example 5 | 1.6 |
| Reference Example 6 | 4.4 |
| Example 1 | 8.7 |
| Example 2 | 8.5 |
| Example 3 | 8.0 |

Comparing the reference examples with one another reveals the reduced instantaneous bond strength on steel brought about by the addition of the additives. The inventive examples, in contrast, exhibit a significantly improved bond strength even as compared with the simple acrylate adhesive component of Reference Example 1, with flame retardancy improved at the same time. The pressure-sensitive adhesives according to the present invention therefore have distinct advantages over existing systems for improving the flame retardancy of acrylate PSAs.

In addition, a determination was made of the residual solvent fraction for the inventive PSA tapes. The results are summarized in Table 3.

TABLE 3
Residual solvent fractions according to test D.

| | Residual solvent content |
|---|---|
| Example | (test D) in [%] |
| Example 1 | 0.3 |
| Example 2 | 0.2 |
| Example 3 | 0.5 |

The values measured are at a very low level and show that the pressure-sensitive adhesive tapes possess very low residual solvent contents.

We claim:

1. Flame-retardant pressure-sensitive adhesive comprising
(a) at least one acrylate adhesive component,
(b) at least one ammonium polyphosphate component and
(c) at least one resin component.

2. Pressure-sensitive adhesive according to claim 1, wherein said at least one acrylate adhesive component comprises at least 35% by weight of the adhesive.

3. Pressure-sensitive adhesive according to claim 1, wherein said at least one ammonium polyphosphate component comprises at least 25% by weight of the adhesive.

4. Pressure-sensitive adhesive according to claim 1, wherein said at least one resin component comprises at least 25% of the adhesive.

5. Pressure-sensitive adhesive according to claim 1, wherein said at least one acrylate adhesive component has an average molecular weight M_{w} of not more than 600,000 g/mol.

6. Pressure-sensitive adhesive according to claim 1, wherein said at least one acrylate adhesive component is based on at least one acrylate monomer of the formula (1) 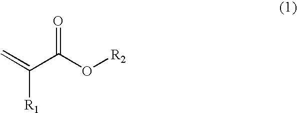
where R₁ is H or a CH₃ radical and R₂ is H or is selected from the group consisting of saturated, branched and unbranched, substituted and unsubstituted C₁ to C₃₀ alkyl radicals.

7. Pressure-sensitive adhesive according to claim 6, wherein R₂ is other than H and has one or more substituents selected from the group consisting of carboxyl, sulphonic acid, hydroxyl, lactam, lactone, N-substituted amide, N-substituted amine, carbamate, epoxy, thiol, alkoxy, cyano, halide and ether radicals.

8. Pressure-sensitive adhesive according to claim 6 or 7, wherein R₂ is selected from the group consisting of saturated, branched and unbranched, substituted and unsubstituted C₄ to C₁₄ alkyl radicals.

9. Pressure-sensitive adhesive according to claim 8, wherein R₂ is selected from the group consisting of bridged and unbridged, substituted and unsubstituted cycloalkyl radicals having at least 6 carbon atoms.

10. Pressure-sensitive adhesive according to claim 6 or 7, wherein said at least one acrylate monomer of formula (1) is a substituted or unsubstituted compound selected from the group consisting of methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, isobutyl acrylate, 2-ethylhexyl acrylate, 2-ethylhexyl methacrylate, isooctyl acrylate, isooctyl methacrylate, cyclohexyl methacrylate, isobornyl acrylate, isobornyl methacrylate and 3,5-dimethyladamantyl acrylate.

11. Pressure-sensitive adhesive according to claim 1, wherein said at least one acrylate adhesive component is based on at least one comonomer as well as on at least one acrylate monomer of the formula (1) 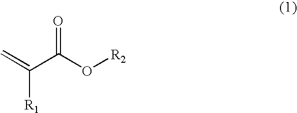
where R₁ is H or a CH₃ radical and R₂ is H or is selected from the group consisting of saturated, branched and unbranched, substituted and unsubstituted C₁ to C₃₀ alkyl radicals.

12. Pressure-sensitive adhesive according to claim 11, wherein said at least one comonomer has one or more substituents selected from the group consisting of carboxyl, sulphonic acid, hydroxyl, lactam, lactone, N-substituted amide, N-substituted amine, carbamate, epoxy, thiol, alkoxy, cyano, halide and ether radicals.

13. Pressure-sensitive adhesive according to claim 11 or 12, wherein said at least one comonomer is a compound selected from the group consisting of N-alkyl-substituted amides.

14. Pressure-sensitive adhesive according to claim 11 or 12, wherein said at least one comonomer is a compound selected from the group consisting of hydroxyethyl acrylate, hydroxyethyl methacrylate, hydroxypropyl acrylate, hydroxypropyl methacrylate, allyl alcohol, maleic anhydride, itaconic anhydride, Itaconic acid, glyceridyl methacrylate, phenoxyethyl acrylate, phenoxyethyl methacrylate, 2-butoxyethyl acrylate, 2-butoxyethyl methacrylate, cyanoethyl acrylate, cyanoethyl methacrylate, glyceryl methacrylate, 6-hydroxyhexyl methacrylate, vinylacetic acid, tetrahydrofurfuryl acrylate, β-acryloyloxypropionic acid, trichloroacrylic acid, fumaric acid, crotonic acid, aconitic acid and dimethylacrylic acid.

15. Pressure-sensitive adhesive according to claim 11 or 12, wherein said at least one comonomer is a compound selected from the group consisting of vinyl esters, vinyl ethers, vinyl halides, vinylidene halides, vinyl compounds having aromatic rings or heterocycles in α-position.

16. Pressure-sensitive adhesive according to claim 11 or 12, wherein said at least one comonomer is a photoiniator having a copolymerizable double bond.

17. Pressure-sensitive adhesive according to claim 11 or 12, wherein an aromatic vinyl compound having C₄ to C₁₈ aromatics or heteroaromatics is added to said at least one comonomer.

18. Pressure-sensitive adhesive according to claim 1 wherein said at least one resin component is selected from the group consisting of pinene resins, indene resins and rosins or their derivatives or salts; aliphatic, aromatic and alkylaromatic C₅ to C₉ hydrocarbon resins; hydrocarbon resins based on single monomers; hydrogenated hydrocarbon resins; substituted and unsubstituted hydrocarbon resins; natural resins; terpene resins and terpene-phenolic resins.

19. A flame-retardant pressure-sensitive adhesive tape, comprising a carrier tape which is impregnated with a flame retardant and is coated on one or both sides with the pressure-sensitive adhesive of claim 1.

20. Flame-retardant pressure-sensitive adhesive tape according to claim 19, wherein the carrier tape used is a nonwoven PET web or a woven/nonwoven composite, or a woven fabric.

21. Flame-retardant pressure-sensitive adhesive tape according to claim 19 or 20, wherein the carrier tape is coated with the pressure-sensitive adhesive as a melt by a hotmelt process.

22. Process for producing a flame-retardant pressure-sensitive adhesive of claim 1, wherein
(a) at least one acrylate adhesive component is prepared by at least partly polymerizing at least one acrylate monomer, optionally in the presence of at least one comonomer, and
(b) successively or simultaneously at least one ammonium polyphosphate component and at least one resin component are combined with the at least one acrylate adhesive component.

23. Process according to claim 22, wherein said at least one acrylate monomer is of the formula (1) 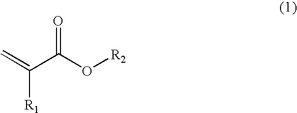
in which R₁ is H or an CH₃ radical and R₂ is H or is selected from the group consisting of saturated, branched and unbranched, substituted and unsubstituted C₁ to C₃₀ alkyl radicals.

24. Process according to claim 22 or 23, wherein the polymerization is conducted in solution or in bulk.

25. Process according to any claim 22 or 23, wherein the at least one ammonium polyphosphate component and the at least one resin component are compounded into a melt of the at least one acrylate adhesive component.

26. Pressure-sensitive adhesive according to claim 3, wherein said amount of said at least one ammonium polyphosphate component is from 30 to 40% by weight of the adhesive.

27. Pressure-sensitive adhesive according to claim 8, wherein R₂ is selected from the group consisting of C₄ to C₉ alkyl radicals

28. Pressure sensitive adhesive according to claim 13, wherein said at least one comonomer is selected from the group consisting of N,N-dimethylacrylamide, N,N-dimethylmethacrylamide, N-tert-butylacrylamide, N-vinylpyrrolidone, N-vinyllactam, dimethylaminoethyl acrylate, dimethylaminoethyl methacrylate, diethylaminoethyl acrylate, diethylaminoethyl methacrylate, N-methylolacrylamide, N-methylolmethacrylamide, N-(butoxymethyl)methacrylamide, N-(ethoxymethyl)acrylamide and N-isopropylacrylamide.

29. Pressure sensitive adhesive according to claim 15, wherein said vinyl compounds having aromatic rings or heterocycles in α-position are selected from the group consisting of vinyl acetate, vinyl formamide, vinylpyridine, ethyl vinyl ether, vinyl chloride, vinylidene chloride and acrylonitrile.

30. Pressure sensitive adhesive according to claim 16, wherein said comonomer is selected from the group consisting of Norrish I photoinitiators, Norrish II photoinitiators, benzoin acrylates and acrylated benzophenones.

31. Flame-retardant pressure-sensitive adhesive tape according to claim 21, wherein said hotmelt process is selected from the group consisting of roller coating, melt die processes and extrusion coating.

32. Process according to claim 25, wherein said components are compounded into a melt by an extrusion process.
